(19) United States
(12) Patent Application Publication
(10) Pub. No.: US 2016/0352759 A1
(43) Pub. Date: Dec. 1, 2016

(54) Utilizing Big Data Analytics to Optimize Information Security Monitoring And Controls

(71) Applicant: Yan ZHAI, Ashburn, VA (US)

(72) Inventor: Yan ZHAI, Ashburn, VA (US)

(21) Appl. No.: 14/720,900

(22) Filed: May 25, 2015

(51) Int. Cl. H04L 29/06; G06N 99/00

(52) U.S. Cl. CPC H04L 63/1416; H04L 63/1425; G06N 99/005

(57) ABSTRACT

Disclosed herein is a method comprising: obtaining one or more responses of a security sensor to events from each of a plurality of sources; clustering each of the sources into one or more clusters, based on an amount of responses of the security sensor to the events from that source; training a classifier with the sources and the clusters they belong; and reconfiguring the security sensor based on the classifier.

### TECHNICAL FIELD

The disclosure relates to the field of information security and big data analytics, in particular to systems and processes of utilizing big data analytics to adjust information security monitoring and control.

### BACKGROUND

Today's information security relies heavily on the effectiveness of security monitoring. Security monitoring may use both the ability to alert on malicious activities and the ability to properly respond to such alarms in a timely fashion.

Over the past decade, large amount of technologies have been developed and deployed to improve the monitoring on potentially harmful activities, such as firewalls, network intrusion detection systems (NIDS), host intrusion detection systems (HIDS), data loss prevention systems (DLP), and security information and event monitoring (SIEM) systems.

A system that monitors activities on a computer system or network and alerts on potentially harmful or suspicious activities may be referred to as a security sensor. Examples of a security sensor may include a network intrusion detection system (NIDS) that monitors packet level network traffic, a host intrusion detection system (HIDS) such as an anti-virus system that monitors local file systems and a data loss prevention system that monitors suspicious data transfer, etc. Most of security sensors work by comparing observed activities against pre-existing threat knowledge (“attack signatures”) and generating alarms when the activities match the pre-existing threat knowledge.

### SUMMARY

Disclosed herein is a method comprising: obtaining one or more responses of a security sensor to events from each of a plurality of sources; clustering each of the sources into one or more clusters, based on an amount of responses of the security sensor to the events from that source; training a classifier with the sources and the clusters they belong; and reconfiguring the security sensor based on the classifier.

According to an embodiment, the events are selected from a group consisting of computer system logs, network device logs, security device logs and alerts, security tool logs and alerts, network packets and flows, and application logs, physical security events, and threat intelligence events.

According to an embodiment, the method further comprises normalizing the events.

According to an embodiment, the method further comprises parsing the events.

According to an embodiment, the events occurred over a period of time greater than a threshold.

According to an embodiment, the source are selected from a group consisting of servers, networks, transmission lines, computer system logs, network device logs, security device logs and alerts, security tool logs and alerts, network packets and flows, and application logs, physical security events, and threat intelligence events and a combination thereof.

According to an embodiment, the security sensor comprises a processor, a memory, a communication interface; the communication interface is coupled to one or more hosts and configured to capture events on the one or more hosts; the memory has instructions and a plurality of attack signatures stored thereon; and when the instructions are executed by the processor, the processor determines one or more responses to the events based on the signatures or rules.

According to an embodiment, reconfiguring the security sensor comprises changing a parameter of one of the attack signatures, adding a new signature into the attack signatures, or eliminating one of the attack signatures.

According to an embodiment, obtaining the one or more responses comprises simulating the security sensor.

According to an embodiment, the method further comprises reducing a dimension of the events.

Disclosed herein is a method comprising: obtaining one or more responses of a security sensor to events from each a plurality of sources; training a classifier with the sources and the responses; reconfiguring the security sensor based on the classifier.

According to an embodiment, the events are selected from a group consisting of computer system logs, network device logs, security device logs and alerts, security tool logs and alerts, network packets and flows, and application logs, physical security events, and threat intelligence events.

According to an embodiment, the method further comprises normalizing the events.

According to an embodiment, the method further comprises parsing the events.

According to an embodiment, the events occurred over a period of time greater than a threshold.

According to an embodiment, the source are selected from a group consisting of servers, networks, transmission lines, computer system logs, network device logs, security device logs and alerts, security tool logs and alerts, network packets and flows, and application logs, physical security events, and threat intelligence events and a combination thereof.

According to an embodiment, the security sensor comprises a processor, a memory, a communication interface; the communication interface is coupled to one or more hosts and configured to capture events on the one or more hosts; the memory has instructions and a plurality of attack signatures stored thereon; when the instructions are executed by the processor, the processor determines one or more responses to the events based on the signatures.

According to an embodiment, reconfiguring the security sensor comprises change a parameter of one of the attack signatures, adding a new signature into the attack signatures, or eliminating one of the attack signatures.

According to an embodiment, obtaining the one or more responses comprises simulating the security sensor.

According to an embodiment, the method further comprises reducing a dimension of the events.

Disclosed herein is a system comprising: a data collection module configured to obtain events from each of a plurality of sources; a clustering module configured to cluster each of the sources into one or more clusters, based on an amount of responses of a security sensor to the events from that source; a classifier training module configured to train a classifier with the sources and the clusters they belong; and a sensor reconfiguration module configured to reconfigure the security sensor based on the classifier.

According to an embodiment, the security sensor comprises a processor, a memory, a communication interface; the communication interface is coupled to one or more hosts and configured to capture events on the one or more hosts; the memory has instructions and a plurality of attack signatures stored thereon; when the instructions are executed by the processor, the processor determines one or more responses to the events based on the attack signatures.

According to an embodiment, the system further comprises a sensor simulation module configured to obtain one or more responses of the security sensor to the events by simulating the security sensor.

According to an embodiment, the system further comprises a feature identification module configured to identify a feature from the events or the responses.

### BRIEF DESCRIPTION OF FIGURES

FIG. 1 schematically shows a host intrusion detection systems (HIDS) as an example of a security sensor.

FIG. 2 schematically shows network intrusion detection systems (NIDS) as an example of a security sensor.

FIG. 3 schematically shows a security sensor deployed in a host that is a part of the infrastructure of a network.

FIG. 4 schematically shows that a security sensor may be deployed in a network that transmits data wirelessly.

FIG. 5 schematically shows that a security sensor may include a plurality of attack signatures.

FIG. 6 and FIG. 7 schematically show a system configured to tune a security sensor, according to an embodiment.

FIG. 8 schematically shows a flow chart for a method of reconfiguring a security sensor.

### DETAILED DESCRIPTION

The present disclosure describes systems and methods for data driven tuning of security sensors, which improves the efficacy of the security sensors.

Security sensors can suffer from two major challenges. First, the volume of alerts a security sensor generates is usually so large that it is not practical for human analysts to review and respond to all the alerts. Second, a large number of the alerts tend to be false alerts (i.e., false positives) that are triggered by legitimate activities instead of malicious ones. False alerts may account for more than 90% of the total alert volume in a large enterprise IT environment.

These challenges may be managed by two approaches: security sensor tuning and alert correlation.

Security sensor tuning is the process of placing a security sensor into an enterprise's IT environment, observing and analyzing the alerts the security sensor generates, and then adjusting or disabling individual attack signatures to reduce the amount of false alerts. Security sensor tuning is usually an on-going process. It starts when a security sensor is first deployed, and continues throughout the life of the security sensor due to the dynamic nature of today's IT environments.

Sensor tuning is a manual process. It may be very time-consuming and demands significant security expertise and deep understanding of the specific IT environments, from human administrators. Therefore, sensor tuning is especially challenging in large enterprise environments because such environments tend to have a large variety of different systems, applications, and services. The large variety may lead to a higher chance of causing the security sensor to generate false alerts. Sensor tuning in such environments demands in-depth knowledge of these environments. When sensor tuning is carried out in such environments, it is usually done against the whole infrastructure instead of specific sub-environments due to resource constraints posed by the complexity of the environments. In a lot of cases, a single attach signature of a source (e.g., an application, a host, or a subnet) may trigger so many false alerts that human administrators often conveniently turn off that attack signature or make it very insensitive for the entire IT environment. However, doing so renders the attack signature essentially useless for the other sources.

Alert correlation is the process of correlating potentially related alerts into more intuitive attack scenarios, based on pre-defined correlation rules in a correlation engine. For example, a correlation rule of “brutal force authentication attack” may look like “Alarm when 100 or more log-on failures occur on the same host within a 30-minute window.” This example avoids generating an alert for each of the 100 or more log-on failures. Instead, it correlates these log-on failures and generates one alert. Another example correlation rule “multiple log-on failures followed by a log-on success” may look like “Alarm when a log-on success occurs after more than 25 consecutive log-on failures on the same user account within 10 minutes.” In a sense, alert correlation extracts a feature from multiple related events. Alert correlation allows suppression of the usually large quantity of alerts and highlights a collection of related events that may fit a valid attack scenario. Such attach scenarios are considered more likely to be associated with real attacks and are of higher risks. Such a correlation engine is called a security information and event monitoring (SIEM) system. A SIEM system can be regarded as a security sensor running on a higher level of abstraction—a SIEM system monitors and alarms on streams of alerts or events, while an ordinary security sensor monitors and alarms on steams of raw data (e.g., network packets). Hence a SIEM may be considered as a special type of security sensor. Like other security sensors, a SIEM may also be tuned to properly adjust its correlation rules to fit the particular IT environment where it is deployed.

One example of security sensor tuning includes imposing a filter to an attack signature, which excludes or includes specific sources from the groups of sources the attack signature applies to. For example, the application of an attack signature for SQL injection attacks may be restricted by a filter to externally accessible web servers. For example, an attack signature may be restricted by a filter to exclude certain subnets which tend to yield lots of false positives. In extreme situations, an attack signature may be completely disabled when it is identified as inapplicable or impractical. Imposing filters may demand very extensive analysis, which may be too much a luxury to have for a complex enterprise environment. Under the pressure of quickly reducing the amount of false positives to practical levels, overly broad or overly narrow filters may be imposed.

Another example of security sensor tuning includes adjusting parameters within an attack signature, which may impact the sensitivity of the security sensor. The parameters may include alarm thresholds. For example, a “brutal force authentication” attack signature in a SIEM will be less sensitive if it is set to trigger an alarm only upon over 1000 log-on failures within 5 minutes instead of 100 log-on failures within 30 minutes. In manual sensor tuning processes, under the pressure of quickly reducing the amount of false positives to practical levels, the sensitivity is often overly reduced due to the existence of one or more “noisy” sources.

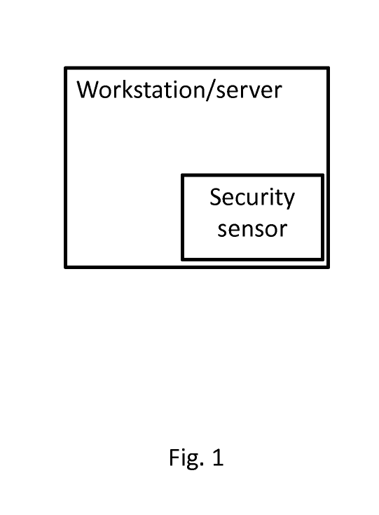

FIG. 1 schematically shows a host intrusion detection systems (HIDS) as an example of a security sensor. The HIDS is deployed in a host (e.g., a server, a workstation) and monitors local file systems of the host and data transfer to and from the host.

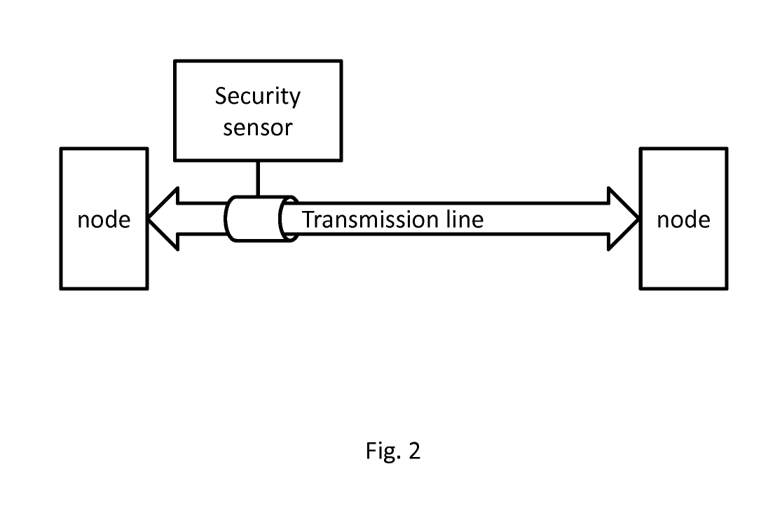

FIG. 2 schematically shows network intrusion detection systems (NIDS) as an example of a security sensor. The NIDS is configured to monitor data on a transmission line (wireless, Ethernet, fiber optics, etc.) between at least a pair of nodes of a network. The nodes can be any device that transmits or receives data. The NIDS can be a standalone device.

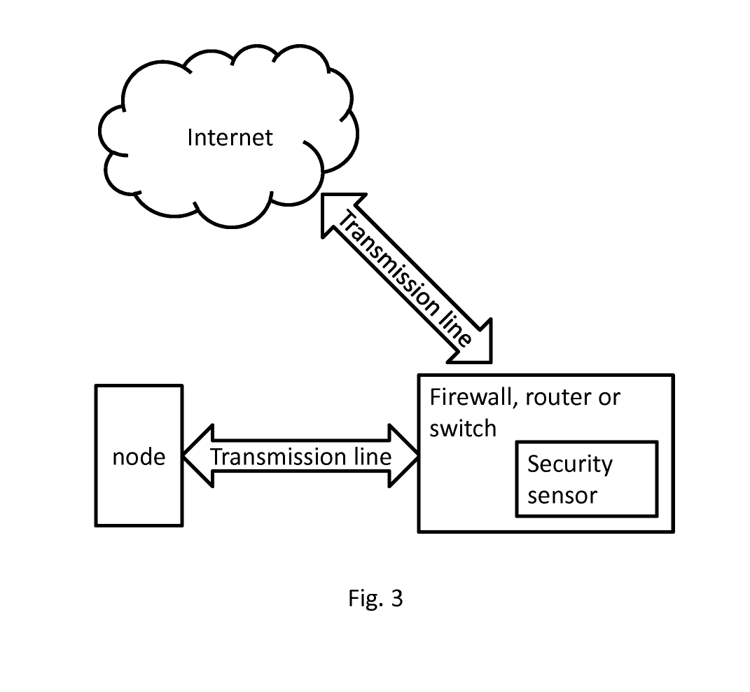

FIG. 3 schematically shows a security sensor deployed in a host that is a part of the infrastructure of a network. The host manages traffic between at least two nodes of the network. One of the nodes may be remote. For example, the host can manage traffic between a local server and the internet. The host may be a router, a switch, or a firewall. The security sensor is an HIDS with respect to the host but a NIDS with respect to the nodes.

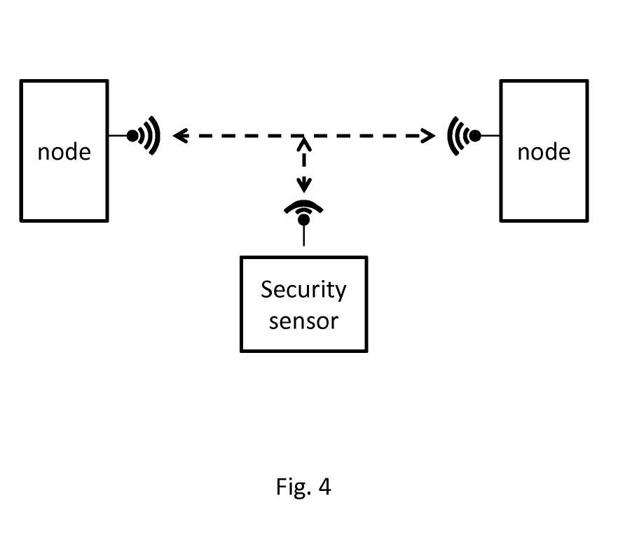

FIG. 4 schematically shows that a security sensor may be deployed in a network that transmits data wirelessly. The security sensor may sniff data in wireless communication without physical connection to any nodes of the network.

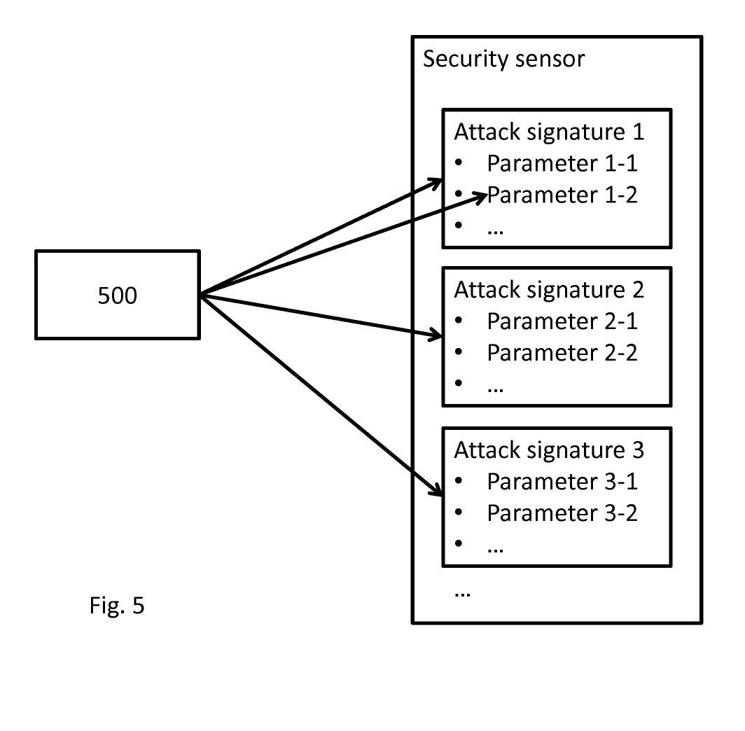

FIG. 5 schematically shows that a security sensor may include a plurality of attack signatures (e.g., Attack Signatures 1, 2 and 3). Each attack signature may contain features extracted from a potential attack. If an event monitored by the security matches an attack signature, the security sensor may further determine how to handle the event. For the security sensor may log the event, do nothing, alert an administrator, quarantine the traffic, user, host or data that caused the event, or even immediately stop all traffic. An example of the attack signature may be attempts of log-on from 100 different IP addresses within 5 minutes. The attack signature may include parameters. In the example above, the parameters may include the number (e.g., 100) of different IP addresses and the time period (e.g., 5 minutes). A system 500 may be configured to tune the security sensor by adjusting the attack signatures. For example, the system 500 may disable or enable the attack signatures, limit the applicability of the attack signatures by time, geological location, logic location, IP addresses, etc. The system 500 may also adjust the parameters of the attack signatures.

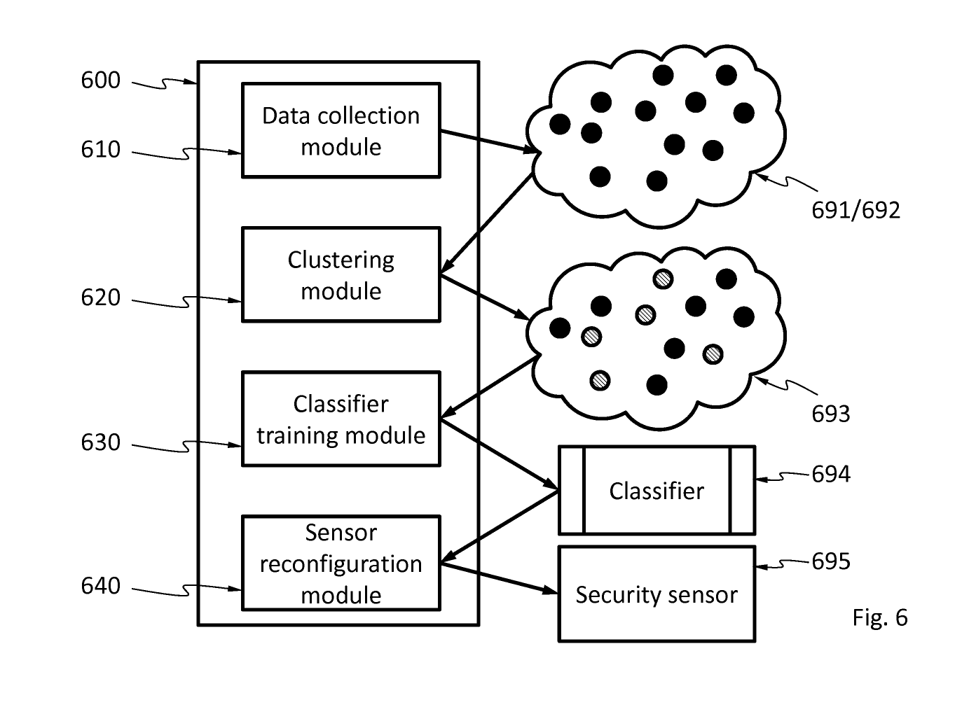

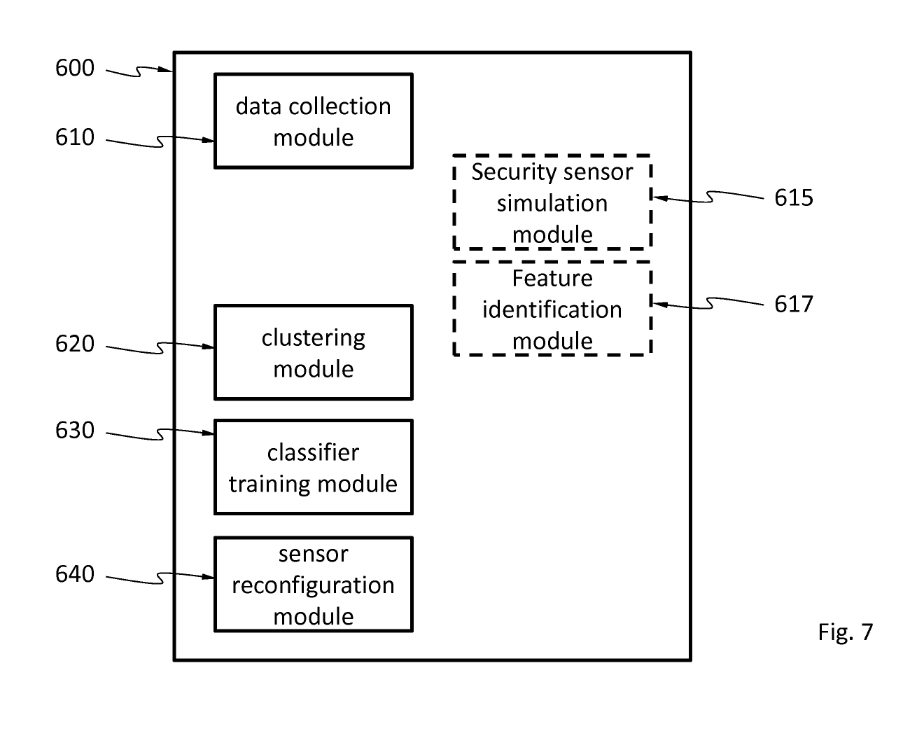

FIG. 6 and FIG. 7 schematically show a system 600 configured to tune a security sensor, according to an embodiment. The system 600 may include a data collection module 610. Data collection module 610 may be configured to collect events 691 the security sensor is configured to monitor. For example, the events may be raw data on a transmission line, or abstraction from the raw data. Examples of the events include system events logs, network device logs, network packet captures, network flows, security tool alerts, application logs, etc. Data collection module 610 may be configured to parse or normalize the events. Data collection module 610 may also be configured to determine the responses 692 of the security sensor to these events 691. The events 691 and responses 692 may span a time period (e.g., a few hours, a few days, a few weeks) that reflects the environment's normal behaviors. One source of the events 691 and the responses 692 is the log of the security sensor. Namely, actual responses of the security sensor to actual events monitored by the security sensor. Alternatively, the data collection module may use the responses 692 of the security sensor to the events 691 simulated by a security sensor simulation module 615 of the system 600. The security sensor simulation module may be configured to simulate the actual alerting against the hosts. The events 691 may be a group of correlated data (as determined by one or more correlation rules). For example, the events 691 may be failed logon attempt counts together with successful logon counts.

In an example, the security sensor simulation module 615 simulates the sensor by:

1. Logging event flow is fed into the simulator based on events' actual time sequence;
2. Monitoring the incoming event flow to perform inspections and correlations like the sensor;
3. Outputting alerts with the triggering events' timestamps when the contents of the event flow matches to one of the attack signatures of the sensor.

The system 600 may include a clustering module 620. The clustering module 620 may be configured to cluster a feature of the events 691 and responses 692 into one or more clusters 693 (different clusters represented by different hatching styles). For example, the feature may be IP addresses, counts of events, traffic port numbers, location labels of the hosts or users, users' group labels, time of the day, day of the week, week of the month, etc. For example, if the events 691 are failed log-on events from a number of IP addresses and the responses 692 are alerts presented to an administrator, clustering module 620 may cluster the IP addresses into two clusters (high alert IPs and lower alert IPs) based on the number of the events 691 from each IP addresses. The feature may be identified by a human or by a feature identification module 617 of the system 600. The clustering module 620 may use a suitable clustering algorithm such as k-means, k-NN, and Random Forest based on the events 691 and the responses 692 to identify groups (i.e., clusters) of the features. For example, the clustering module 620 may include entities (e.g., hosts, IP addresses) that yield a similar amount of alerts into a cluster. When multiple features are used in the clustering, dimension reduction techniques such as Principle Component Analysis (PCA) can be applied to the events 691 and responses 692 before performing the clustering. The clustering module 620 may be optimized based on metrics such as the Silhouette coefficient and the Davies-Bouldin index.

The system 600 may include a classifier training module 630. The classifier training module 630 uses the characteristics of the clusters to train a classifier 694. The classifier 694 can classify events into the clusters (e.g., based on the feature). Various classifiers (such as random forest, artificial neutral network, decision tree and frequency based models) can be used.

The system 600 may include a sensor reconfiguration module 640. The sensor reconfiguration module 640 can be configured to adjust a security sensor 695 based on characteristics of the classifier 694.

### Example 1

The classifier 694 classifies a collection of hosts into a cluster of hosts yielding high false positives for an attack signature. This collection of hosts but no other hosts can be excluded from the attack signature by applying a filter to the attack signature.

### Example 2

The classifier 694 classifies a collection of hosts into a cluster of hosts tending to have a high count of authentication failures on a daily basis. A sub-attack signature may be created from an attack signature for brutal force authentication, where the sub-attack signature only applies to this collection of hosts with properly set threshold so it only yields acceptable amount of alerts, while for the rest of the environment, lower threshold can still be applied to maintain proper monitoring.

### Example 3

The classifier 694 classifies a collection of hosts into a cluster of hosts that have a high count of authentication failures within certain hours of the day (e.g., working hours during week days). An attack signature for authentication failures may be broken into two rules for the “peak hours” and “non-peak hours,” respectively.

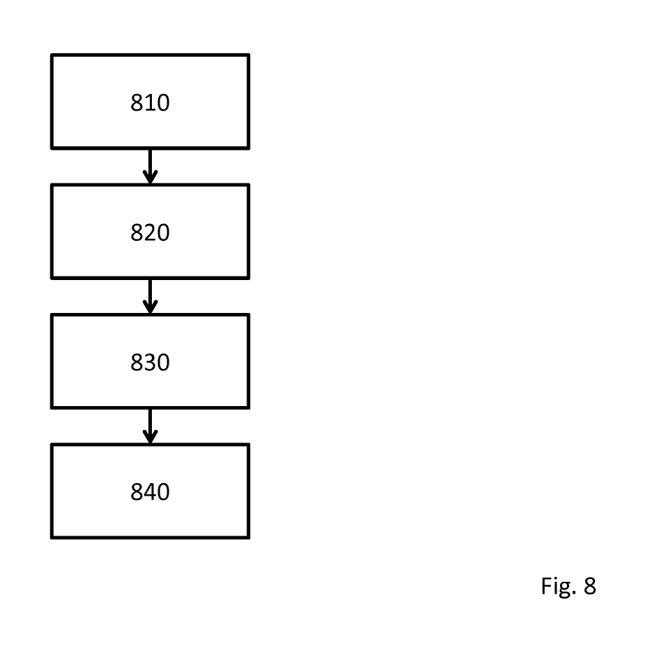

FIG. 8 schematically shows a flow chart for a method of reconfiguring a security sensor. In 810, obtain one or more responses of a security sensor to events from each of a plurality of sources. The events may be computer system logs, network device logs, security device logs and alerts, security tool logs and alerts, network packets and flows, and application logs, physical security events, or threat intelligence events. The events may be normalized or parsed. The events may have occurred over a period of time greater than a threshold. The one or more responses may be obtained by simulating the security sensor.

In 820, cluster each of the sources into one or more clusters, based on an amount of responses of the security sensor to the events from that source.

In 830, train a classifier with the sources and the clusters they belong. In 840, reconfigure the security sensor based on the classifier. The source are selected from a group consisting of servers, networks, transmission lines, computer system logs, network device logs, security device logs and alerts, security tool logs and alerts, network packets and flows, and application logs, physical security events, and threat intelligence events and a combination thereof.

The security sensor may comprise a processor, a memory, a communication interface. The communication interface is coupled to one or more hosts and configured to capture events on the one or more hosts. The memory has instructions and a plurality of attack signatures stored thereon. When the instructions are executed by the processor, the processor determines one or more responses to the events based on the attack signatures.

Reconfiguring the security sensor may include changing a parameter of one of the attack signatures, adding a new signature into the attack signatures, or eliminating one of the attack signatures.

The method may comprises reducing a dimension of the events.

The term “information security” as used in the present disclosure at least includes network security, data security, host security, and application security.

The term “security controls” as used in the present disclosure refers to restrictions deployed to secure information technology infrastructure, data, and services. Security controls may include restrictions of accesses on various levels, various policies and procedures applied to IT practices, and the monitoring of the enforcements of the aforementioned restrictions. Examples of security controls include identity and access management (IAM), firewalls, and encryption.

The term “security monitoring” as used in the present disclosure refers to the tools and procedures for monitoring the enforcement of security controls and the general health of the security posture of information technology infrastructure, application, service, and information assets. Examples of security monitoring include intrusion detection systems (IDS), data loss prevention (DLP) systems, security information and event monitoring (SIEM) systems.

The term “intrusion detection systems” (IDS) as used in the present disclosure, may include two types of intrusion detection systems: network IDS (NIDS) and host IDS (HIDS). NIDS is deployed in a network to inspect the network traffic for predefined packet or traffic patterns that are considered potential intrusions. HIDS is deployed on individual hosts (e.g., servers and workstations) to monitor system and network events happening on the host for potential intrusion behaviors.

The term “intrusion prevention system” (IPS) as used in the present disclosure, refers to a system that inspects traffic and a program in a network or host and is capable of immediately blocking the traffic or program when it is found to be intrusive.

The term “IDS tuning” as used in the present disclosure, refers to the process of adjusting an IDS, such as adjusting an attack rule or a parameter of the IDS.

The term “Security Information & Event Monitoring system” (SIEM) as used in the present disclosure, refers to a security sensor that monitors logs and events from all the enrolled hosts, devices, and security monitoring agents such as IDS and IPS. A SIEM system can process a stream of events in real-time and match them against pre-defined correlation rules.

The term “SIEM tuning” as used in the present disclosure is a special kind of IDS tuning, where a correlation rule of the SIEM is adjusted.

The term “parsing” as used herein is the process of analyzing a string of symbols into logical syntactic components. For example, a firewall event log entry “2015-05-11 11:04:48 src:10.10.10.2 dst:10.10.9.3 proto:tcp sport:80 action:accept” can be parsed into a collection of fields: date=“2015-05-11,” time=“11:04:48,” source ip=“10.10.10.2,” destination ip=“10.10.9.3,” protocol=“tcp,” service port=“80,” firewall action=“accept.” The script or program that performs parsing is called a parser.

The term “normalization” as used herein means making the scales of two or more values the same. For example, if one network device reports traffic volume by bytes and another network device reports traffic volume by mega-bytes, normalization can convert one or both the traffic volumes to the same scale (e.g., mega-bytes, bytes, bits, etc.).

The term “clustering” as used in the present disclosure, refers to a task of grouping a set of objects in such a way that objects in the same group (called a cluster) are more similar (in some sense or another) to each other than to those in other groups (clusters). Clustering may be use for data mining. A clustering algorithm analyzes a collection of objects by measuring the similarities among them based on one or more features of the objects, and splits the objects into one or more clusters. Examples of clustering algorithms include k-nearest neighbor (k-NN) algorithm and k-means algorithm.

The term “statistical classification” as used in the present disclosure, refers to process of identifying to which of a set of categories (sub-populations or classes) an observation belongs, based on a training set of data containing observations whose classes are known.

The term “classifier” as used in the present disclosure, refers to an algorithm or process that implements classification. Examples of classification algorithms include support vector machines, logistic regression, Naïve Bayes, k-nearest neighbor, random forest, and artificial neural networks (ANNs).

The term “random forest” as used in the present disclosure, refers to an ensemble learning method for classification, regression and clustering, that operate by constructing a multitude of decision trees at training time and outputting the class that is the mode of the classes (classification) or mean prediction (regression) of the individual trees.

The term “Principle Component Analysis” (PCA) as used in the present disclosure, refers to a statistical procedure that uses an orthogonal transformation to convert a set of observations of possibly correlated variables into a set of values of linearly uncorrelated variables called principal components. The number of principal components is less than or equal to the number of original variables.

The descriptions above are intended to be illustrative, not limiting. Thus, it will be apparent to one skilled in the art that modifications may be made without departing from the scope of the claims set out below.

What is claimed is:

1. A method comprising:
obtaining one or more responses of a security sensor to events from each of a plurality of sources;
clustering each of the sources into one or more clusters, based on an amount of responses of the security sensor to the events from that source;
training a classifier with the sources and the clusters they belong; and
reconfiguring the security sensor based on the classifier.

2. The method of claim 1, wherein the events are selected from a group consisting of computer system logs, network device logs, security device logs and alerts, security tool logs and alerts, network packets and flows, and application logs, physical security events, and threat intelligence events.

3. The method of claim 1, further comprising normalizing the events.

4. The method of claim 1, further comprising parsing the events.

5. The method of claim 1, wherein the events occurred over a period of time greater than a threshold.

6. The method of claim 1, wherein the source are selected from a group consisting of servers, networks, transmission lines, computer system logs, network device logs, security device logs and alerts, security tool logs and alerts, network packets and flows, and application logs, physical security events, and threat intelligence events and a combination thereof.

7. The method of claim 1,
wherein the security sensor comprises a processor, a memory, a communication interface;
wherein the communication interface is coupled to one or more hosts and configured to capture events on the one or more hosts;
wherein the memory has instructions and a plurality of attack signatures stored thereon;
wherein when the instructions are executed by the processor, the processor determines one or more responses to the events based on the signatures.

8. The method of claim 7, wherein reconfiguring the security sensor comprises change a parameter of one of the attack signatures, adding a new signature into the attack signatures, or eliminating one of the attack signatures.

9. The method of claim 1, wherein obtaining the one or more responses comprises simulating the security sensor.

10. The method of claim 1, further comprising reducing a dimension of the events.

11. A method comprising:
obtaining one or more responses of a security sensor to events from each a plurality of sources;
training a classifier with the sources and the responses;
reconfiguring the security sensor based on the classifier.

12. The method of claim 11, wherein the events are selected from a group consisting of computer system logs, network device logs, security device logs and alerts, security tool logs and alerts, network packets and flows, and application logs, physical security events, and threat intelligence events.

13. The method of claim 11, further comprising normalizing the events.

14. The method of claim 11, further comprising parsing the events.

15. The method of claim 11, wherein the events occurred over a period of time greater than a threshold.

16. The method of claim 11, wherein the source are selected from a group consisting of servers, networks, transmission lines, computer system logs, network device logs, security device logs and alerts, security tool logs and alerts, network packets and flows, and application logs, physical security events, and threat intelligence events and a combination thereof.

17. The method of claim 11,
wherein the security sensor comprises a processor, a memory, a communication interface;
wherein the communication interface is coupled to one or more hosts and configured to capture events on the one or more hosts;
wherein the memory has instructions and a plurality of attack signatures stored thereon;
wherein when the instructions are executed by the processor, the processor determines one or more responses to the events based on the signatures.

18. The method of claim 17, wherein reconfiguring the security sensor comprises change a parameter of one of the attack signatures, adding a new signature into the attack signatures, or eliminating one of the attack signatures.

19. The method of claim 11, wherein obtaining the one or more responses comprises simulating the security sensor.

20. The method of claim 11, further comprising reducing a dimension of the events.

21. A system comprising:
a data collection module configured to obtain events from each of a plurality of sources;
a clustering module configured to cluster each of the sources into one or more clusters, based on an amount of responses of a security sensor to the events from that source;
a classifier training module configured to train a classifier with the sources and the clusters they belong; and
a sensor reconfiguration module configured to reconfigure the security sensor based on the classifier.

22. The system of claim 21, wherein the security sensor comprises a processor, a memory, a communication interface;
wherein the communication interface is coupled to one or more hosts and configured to capture events on the one or more hosts; wherein the memory has instructions and a plurality of attack signatures stored thereon;
wherein when the instructions are executed by the processor, the processor determines one or more responses to the events based on the attack signatures.

23. The system of claim 21, further comprising a sensor simulation module configured to obtain one or more responses of the security sensor to the events by simulating the security sensor.

24. The system of claim 21, further comprising a feature identification module configured to identify a feature from the events or the responses.
